(19) United States
(12) Patent Application Publication
(10) Pub. No.: US 2026/0191218 A1
(43) Pub. Date: Jul. 9, 2026

(54) IMITATION CHEESE, METHOD FOR PRODUCING IMITATION CHEESE, AND FOOD PRODUCT CONTAINING IMITATION CHEESE

(71) Applicant: ADEKA CORPORATION, Tokyo (JP)

(72) Inventors: Kazumasa ABE, Tokyo (JP); Satoru OZAKI, Tokyo (JP); Kazuhiro SASAKI, Tokyo (JP)

(21) Appl. No.: 19/133,089

(22) PCT Filed: Dec. 1, 2023
(86) PCT No.: PCT/JP2023/043052

§ 371 Date: May 27, 2025

(30) Foreign Application Priority Data
Dec. 1, 2022 (JP) 2022-192907

(51) Int. Cl. A23C 20/02

(52) U.S. Cl. CPC A23C 20/02

(57) ABSTRACT

Provided is an imitation cheese with a good taste, good processing suitability, good processing stability over time such as not losing its processing suitability even after time has elapsed since its production, and good heat-melting properties with moderate melting and stickiness enough not to flow out upon heating. The imitation cheese includes (A) a nut and seed, (B) a starch treated with oxidation, (C) a starch treated with hydroxypropylation, and (D) a fat and oil, satisfies the following (Condition 1), and has a pH of 3.0 to 6.0:

(Condition 1): a content of a tri-saturated triglyceride formed of solely saturated fatty acid residues having the carbon number of 12 to 22 in a triglyceride composition in an oil phase is in the range of 30.0 to 70.0% by mass.

### CROSS-REFERENCE TO RELATED APPLICATIONS

This application is the U.S. National Phase under 35 U.S.C. § 371 of International Application No. PCT/JP2023/043052, filed on Dec. 1, 2023, which in turn claims the benefit of Japanese Application No. 2022-192907, filed Dec. 1, 2022, and the entire contents of each of which are hereby incorporated by reference.

### TECHNICAL FIELD

The present invention relates to an imitation cheese, a method for producing the imitation cheese, and a food product containing the imitation cheese.

### BACKGROUND ART

Cheese is one of the dairy products produced by a process including coagulation, fermentation, aging, and the like, using a raw material derived from milk from cow, water buffalo, sheep, goat, yak, or the like.

Cheese made from a milk-derived raw material can not be eaten by vegetarians and is unstable in terms of supply, thereby being susceptible to a price hike of the milk-derived raw material. Therefore, there is a need for an imitation cheese that is not affected by these problems, being produced without using a milk-derived raw material.

Cheese has a distinctive taste that combines richness, fullness, and acidity, and there has been a demand for an imitation cheese having a taste similar to those of the cheese. In addition, cheese is often used by shredding large chunks of a cheese into strips, diced, or processed into any size or shape, for example, to make it easier to use in cooking. Therefore, the processing suitability for such processing is also required for the imitation cheese. In addition to the processing suitability, there is a need for the imitation cheese also to have good heat-melting properties such as moderate melting with viscosity when it is cooked with heat.

However, the characteristics of cheese, such as a taste, processing suitability, and heat-melting properties, are largely owing to a milk-derived protein contained in the cheese; thus, simply reducing the protein like this would cause problems such as a reduced taste, loss of shape retention, reduced processing suitability, and complete meltdown to cause the flow of it during cooking with heat.

Studies of the imitation cheese that is obtained using a plant-derived protein instead of the milk-derived protein and yet satisfies the required characteristics of the cheese have been carried out.

For example, Patent Literature 1 discloses a food composition characterized in that it has a cheese-like tissue, containing a soybean protein with an amount of 0.5 to 10% by mass in terms of a solid component and a wheat protein with an amount of 15 to 35% by mass in terms of a solid component, relative to the whole amount of the food composition, and that the soybean protein is coagulated.

Patent Literature 2 discloses a non-dairy cheese substitute containing a coacervate containing one or more proteins isolated and refined from a non-animal source.

Patent Literature 3 discloses a plant food product similar to an unrefined solid cheese, characterized in that it contains crushed nuts, preferably in the form of puree, and at least one plant fat, at least one starch source, at least one natural acidifying ingredient, as well as optionally, at least one plant dietary fiber source, and water, without containing an additive.

Another study has also been carried out on the use of a starch as a skeleton, rather than a protein, to meet the required characteristics of the cheese.

For example, Patent Literature 4 discloses a cheese-like processed food that contains a milk protein with a content of 0.1% by mass or less, an oxidized starch, a hydroxypropyl starch, a fat and oil having a slip melting point of 30° C. or higher, and water, in which the content of an amylose in the entire oxidized starch is 0.1 to 23% by mass, claiming that this food product has a certain degree of stringiness when heated even though there is practically no milk protein contained.

Patent Literature 5 discloses a cheese-like food product containing an acetylated oxidized starch with an amount of 2% by mass or more and 30% by mass or less, an edible fat and oil with an amount of 10% by mass or more and 35% by mass or less, and water with an amount of 30% by mass or more and 65% by mass or less, in which an amount of the edible fat and oil in terms of a content of a solid fat at 10° C. is 20% or more and 95% or less.

### RELATED ART REFERENCE

### Patent Literature

Patent Literature 1: Japanese Patent Application Laid-open No. 2011-000073
Patent Literature 2: Japanese Patent Application Laid-open No. 2019-122388
Patent Literature 3: Japanese Patent Application Laid-open No. 2022-027690
Patent Literature 4: Japanese Patent Application Laid-open No. 2018-174712
Patent Literature 5: International Publication WO No. 2020/045175

### SUMMARY OF INVENTION

### Problem to be Solved by the Invention

The imitation cheeses conventionally studied and disclosed have the following problems.

Imitation cheeses, disclosed in Patent Literatures 1 and 2, made from a plant protein obtained from legumes such as a soybean and grains have problems of being inferior in terms of a taste, because the unique tastes of legumes and grains are easily perceived as an odd taste.

The plant-based food product of Patent Literature 3 is excellent in terms of a taste, with little odd taste, but it fails to achieve a good processing suitability or cheese-like heat-melting properties, such as moderate melting and stickiness when heated.

The cheese-like processed foods of Patent Literature 4 and the cheese-like foods of Patent Literature 5 either do not contain a protein or contain only a small amount of a protein, and thus have a weak taste as a cheese. Although the starch skeleton has the advantage of having a hardness suitable for processing, there have been problems that the cheese-like product is brittle and crumbles when shredded, diced, or the like, and the stickiness causes the cheese-like product to stick to a processing machine, or to stick to other cheese-like product or among themselves, making it difficult to process the cheese-like food product into the desired shape. There has also been a room for improvement in the heat-melting properties.

The cheese and imitation cheese, which are shredded into strips, diced, etc., are often stored for a certain period of time in a pre-processed state and then processed just before they are used for cooking. The physical properties of these conventionally known imitation cheeses change over time from production to processing, thereby easily crumbling or generating shavings and powders during processing, or becoming sticky, resulting in loss of processing suitability. Therefore, stable processing suitability over time (hereinafter this is also referred to as “processing stability over time”), which allows processing without problems even after a time has elapsed after the production thereof, is required.

Thus, an object of the present invention is to obtain an imitation cheese that satisfies all of the following 1) to 4).
1) Good taste.
2) Excellent processing suitability.
3) Good processing stability over time, such as not losing its processing suitability due to changes in physical properties, etc. of an imitation cheese, even after time has elapsed since its production.
4) Good heat-melting properties, such as moderate melting and stickiness enough not to flow out when heated.

### Means for Solving Problem

The inventors of the present invention extensively carried out the research for solving the aforementioned problems. As a result, they found that the problems described above can be solved by an imitation cheese having the following configuration and thus achieved the present invention.

(1) An imitation cheese comprising (A) a nut and seed, (B) a starch treated with oxidation, (C) a starch treated with hydroxypropylation, and (D) a fat and oil, the imitation cheese satisfying the following (Condition 1) and having a pH of 3.0 to 6.0:

(Condition 1): a content of a tri-saturated triglyceride formed of solely saturated fatty acid residues having the carbon number of 12 to 22 in a triglyceride composition in an oil phase is in the range of 30.0 to 70.0% by mass.

(2) The imitation cheese according to (1), wherein an oil content in the ingredient (A) is 35.0% by mass or less.

(3) The imitation cheese according to (1) or (2), wherein the ingredient (A) is an almond-derived protein material.

(4) The imitation cheese according to (1) or (2), wherein a ratio of a content of the ingredient (C) to a starch content in the imitation cheese is in the range of 5.0 to 40.0% by mass.

(5) The imitation cheese according to (3), wherein a ratio of a content of the ingredient (C) to a starch content in the imitation cheese is in the range of 5.0 to 40.0% by mass.

(6) The imitation cheese according to one of (1) to (5), further satisfying (Condition 2) below:

(Condition 2): a content of tri-laurin in the triglyceride composition in the oil phase is in the range of 5.0 to 30.0% by mass.

(7) A method for producing an imitation cheese, the imitation cheese including (A) a nut and seed, (B) a starch treated with oxidation, (C) a starch treated with hydroxypropylation, and (D) a fat and oil; the imitation cheese satisfying (Condition 1) below and having a pH of 3.0 to 6.0, the method comprising (Step 1) to (Step 5) below:
(Condition 1): a content of a tri-saturated triglyceride formed of solely saturated fatty acid residues having the carbon number of 12 to 22 in a triglyceride composition in an oil phase is in the range of 30.0 to 70.0% by mass;
(Step 1): a step of obtaining a mixture that contains the ingredients (A) to (D) described above and satisfies (Condition 1);
(Step 2): a step of adjusting a pH of the mixture to 3.0 to 6.0;
(Step 3): a step of homogenizing the mixture;
(Step 4): a step of heating the pH-adjusted mixture to 80° C. or higher; and
(Step 5); a step of cooling the mixture having been heated to 80° C. or higher to 20° C. or lower.

(8) A food product containing the imitation cheese according to one of (1) to (6).

### Effect of the Invention

According to the present invention, it is possible to obtain the imitation cheese that satisfies all the following 1) to 4).
1) Good taste.
2) Excellent processing suitability.
3) Good processing stability over time, such as not losing its processing suitability due to changes in physical properties, etc. of an imitation cheese, even after time has elapsed since its production.
4) Good heat-melting properties, such as moderate melting and stickiness enough not to flow out when heated.

### EMBODIMENT FOR CARRYING OUT THE INVENTION

Hereinafter, the present invention will be described according to its suitable embodiments. The present invention is not limited by the following description, and each constituent element may be appropriately modified without departing from the scope of the present invention.

### [Imitation Cheese]

The imitation cheese according to the present invention is characterized in that it contains (A) a nut and seed, (B) a starch treated with oxidation, (C) a starch treated with hydroxypropylation, and (D) a fat and oil, and satisfies following (Condition 1) with a pH of 3.0 to 6.0.

(Condition 1): A content of a tri-saturated triglyceride formed of solely saturated fatty acid residues having the carbon number of 12 to 22 in a triglyceride composition in an oil phase is 30.0 to 70.0% by mass.

### <(A) Nut and Seed>

The imitation cheese according to the present invention contains a nut and seed as an ingredient A.

The “nuts and seeds” in the present invention refers to edible fruits and seeds that are encased in a hard peel or shell, other than beans and grains. Although Arachis hypogaea (peanut) belongs to the Laguminosae according to the plant taxonomy, peanut is treated as nuts and seeds due to their high oil content; so peanut is also regarded as nuts and seeds in the present invention.

Examples of the nut and seed used in the present invention include an almond, a hemp, a linseed, an apricot kernel, a perilla, a cashew nut, a ginkgo nut, a chestnut, a walnut, a poppy, a coconut, a sesame, a sweet acorn, a chia seed, a horse chestnut, a pistachio, a sunflower seed, a Brazil nut, a hazelnut, a pecan, a macadamia nut, and a peanut. One type, or two or more types selected from those described above may be used. Processed materials from these nuts and seeds may also be used.

Examples of the processed material include, (i) a nut and seed that is processed itself, such as powdered or pasted nut and seed, (ii) a certain ingredient that is isolated or concentrated from a nut and seed, such as a protein derived from a nut and seed and a carbohydrate derived from a nut and seed, and (iii) plant milk of a nut and seed, such as almond milk, coconut milk, among others. fat and oil derived from a nut and seed, such as a sesame oil and a sunflower oil, shall be regarded as (D) the fat and oil to be described later and shall not be included in (A) the nut and seed.

In the imitation cheese according to the present invention, from the viewpoints of a good taste, good processing suitability, good processing stability over time, and good heat-melting properties, it is preferable to use, among these nuts and seeds as the raw materials thereof, one, or two or more selected from an almond, an apricot kernel, a cashew nut, a walnut, a coconut, a pistachio, a hazelnut, a macadamia nut, and a peanut; it is more preferable to use one, or two or more selected from an almond, a cashew nut, a pistachio, and a peanut; it is far more preferable to use an almond.

From the viewpoint of obtaining good processing suitability, good processing stability over time, and good heat-melting properties, it is preferable to use a certain ingredient isolated or concentrated from the nut and seed, and it is more preferable to use a protein material derived from the nut and seed.

Thus, in one particularly suitable embodiment, the ingredient (A) is a protein material derived from an almond.

The term “protein material derived from an almond” in the present invention refers to a material in which an almond is processed to increase the protein content thereof, and specifically refers to an almond-derived material with a protein content of 30.0% by mass or more.

There is no particular restriction in the form of the nut and seed used in the present invention; for example, the nut and seed may be in their original form, or in the form of a liquid, a paste, or a powder.

In the imitation cheese according to the present invention, from the viewpoint of obtaining a more favorable taste, the oil content in the nut and seed is preferably 35.0% by mass or less, more preferably 30.0% by mass or less, and far more preferably 25.0% by mass or less. The lower limit of the oil content in the nut and seed is 0% by mass, and the oil content is preferably 0.1% by mass or more, more preferably 1.0% by mass or more. Accordingly, in one suitable embodiment, the oil content in the ingredient (A) is 35.0% by mass or less.

As for the method of measuring the oil content in the nut and seed, any conventionally known method may be used. Examples of the measurement method include an ether extraction method, a chloroform/methanol mixed liquid extraction method, and an acid decomposition method. In the present invention, the measurement may be performed by the ether extraction method.

Hereinafter, the same applies to the method of measuring the oil content in the imitation cheese according to the present invention.

In the imitation cheese according to the present invention, from the viewpoints of a better taste, better processing suitability, better processing stability over time, and better heat-melting properties, the protein content in the nut and seed is preferably 30.0% by mass or more, more preferably 32.0% by mass or more, and far more preferably 35.0% by mass or more. The maximum value of the protein content in the nut and seed used in the present invention is 100% by mass, preferably 95.0% by mass or less, more preferably 80.0% by mass or less, far more preferably 70.0% by mass or less, and especially preferably 65.0% by mass or less.

As for the method of measuring the protein content in the nut and seed, any conventionally known method may be used. Examples of the measurement method include a Kjeldahl method and a combustion method. In the present invention, the measurement may be performed by a combustion method.

Hereinafter, the same applies to the method of measuring the protein content in the imitation cheese according to the present invention.

In the imitation cheese according to the present invention, from the viewpoints of better processing suitability, better processing stability over time, and better heat-melting properties, the carbohydrate content in the nut and seed is preferably 50.0% by mass or less, more preferably 45.0% by mass or less, and far more preferably 40.0% by mass or less. The lower limit of the carbohydrate content in the nut and seed is 0% by mass.

As for the method of measuring the carbohydrate content in the nut and seed, any conventionally known method may be used. For example, the content of the carbohydrate in the nut and seed may be calculated by subtracting the sum of the separately measured content of the protein, oil, ash, and water in the nut and seed from the weight of the nut and seed, and the resulting amount of the carbohydrate in the nut and seed is divided by the weight of the nut and seed.

Hereinafter, the same applies to the method of measuring the carbohydrate content in the imitation cheese according to the present invention.

From the viewpoints of a better taste, better processing suitability, better processing stability over time, and better heat-melting properties, the content of the nut and seed in the imitation cheese according to the present invention in terms of the protein content is 0.2% by mass or more, more preferably 0.3% by mass or more, far more preferably 0.4% by mass or more, especially preferably 0.5% by mass or more, and the upper limit thereof is preferably 5.0% by mass or less, more preferably 4.0% by mass or less, far more preferably 3.0% by mass or less, and especially preferably 2.5% by mass or less in terms of the protein content. Accordingly, in one embodiment, in the imitation cheese according to the present invention, the content of the ingredient (A) in terms of the protein content is preferably in the range of 0.2 to 5.0% by mass, more preferably in the range of 0.3 to 4.0% by mass, far more preferably in the range of 0.4 to 3.0% by mass, and especially preferably in the range of 0.5 to 2.5% by mass.

<(B) Starch Treated with Oxidation>

The imitation cheese according to the present invention contains a starch treated with oxidation as the ingredient (B).

The term “starch treated with oxidation” in the present invention refers to the processed starch obtained by oxidizing a raw material starch with sodium hypochlorite or the like.

The type of the raw material starch for the starch treated with oxidation used in the present invention is not particularly restricted. Examples thereof include a waxy corn-derived starch, a corn-derived starch, a tapioca-derived starch, a wheat-derived starch, a sweet potato-derived starch, a potato-derived starch, a sago-derived starch, and a rice-derived starch. As these raw material starches, one type thereof may be used, or two or more types thereof may be used in combination.

In the imitation cheese according to the present invention, from the viewpoints of better processing suitability, better processing stability over time, and better heat-melting properties, it is preferable to use the starch treated with oxidation that is produced using, among these raw material starches, one, or two or more raw material starches selected from a tapioca-derived starch and a potato-derived starch.

The starch treated with oxidation used in the present invention may be treated with, in addition to oxidation, one, or two or more treatments selected from physical treatments such as a bleaching treatment or a wet heating treatment, chemical treatments such as an esterification treatment, an etherification treatment, an acetylation treatment, a hydroxypropylation treatment, a phosphorylation treatment, a cross-linking treatment, or an emulsification treatment, and an enzymatic treatment. In the present invention, it is preferable to use the starch that has been treated only with oxidation.

In the present invention, if oxidation treatment is applied, all starch is regarded as (B) the starch treated with oxidation, even if it has undergone treatments other than the oxidation treatment.

As the starch treated with oxidation in the imitation cheese according to the present invention, one type thereof may be used alone, or two or more types thereof may be used in combination. Two or more starches treated with oxidation that are produced from the same type of the raw material starch but have different oxidation degrees may be used in combination.

From the viewpoints of better processing suitability, better processing stability over time, and better heat-melting properties, the content of the starch treated with oxidation in the imitation cheese according to the present invention is preferably 5.0% by mass or more, more preferably 7.0% by mass or more, far more preferably 9.0% by mass or more, or 10.0% by mass or more, and the upper limit thereof is preferably 25.0% by mass or less, more preferably 22.0% by mass or less, and far more preferably 20.0% by mass or less. Accordingly, in one embodiment, the content of the ingredient (B) in the imitation cheese according to the present invention is preferably in the range of 5.0 to 25.0% by mass, more preferably in the range of 7.0 to 22.0% by mass, and far more preferably in the range of 10.0 to 20.0% by mass.

From the viewpoint of better heat-melting properties, the ratio of the content of (B) the starch treated with oxidation to the content of the starch in the imitation cheese according to the present invention is preferably 60.0% by mass or more, more preferably 70.0% by mass or more, far more preferably 75.0% by mass or more, or 80.0% by mass or more, and the upper limit thereof is preferably 95.0% by mass or less, more preferably 93.0% by mass or less, and far more preferably 91.0% by mass or less, or 90.0% by mass or less. Accordingly, in one embodiment, the ratio of the content of the ingredient (B) to the content of the starch in the imitation cheese according to the present invention is preferably in the range of 60.0 to 95.0% by mass, more preferably in the range of 70.0 to 93.0% by mass, and far more preferably in the range of 75.0 to 90.0% by mass.

The starch content in the imitation cheese according to the present invention is the sum of (B) the starch treated with oxidation, (C) the starch treated with hydroxypropylation, and other starches to be described later.

<(C) Starch Treated with Hydroxypropylation>

The imitation cheese according to the present invention contains a starch treated with hydroxypropylation as the ingredient (C).

The term “starch treated with hydroxypropylation” in the present invention refers to the hydroxypropylated starch obtained by treating the raw material starch with hydroxypropylation by propylene oxide or the like, as well as the starch treated with, in addition to the hydroxypropylation, one, or two or more treatments selected from physical treatment, chemical treatment, and enzymatic treatment. In the imitation cheese according to the present invention, one, or two or more starches selected from those described above may be used.

The type of the raw material starch for the starch treated with hydroxypropylation used in the present invention is not particularly restricted. Examples thereof include a waxy corn-derived starch, a corn-derived starch, a tapioca-derived starch, a wheat-derived starch, a sweet potato-derived starch, a potato-derived starch, a sago-derived starch, and a rice-derived starch. As these raw material starches, one type thereof may be used, or two or more types thereof may be used in combination.

In the imitation cheese according to the present invention, from the viewpoints of better processing suitability, better processing stability over time, and better heat-melting properties, it is preferable to use, among these raw material starches, the starch that is treated with hydroxypropylation and is produced using one, or two or more raw material starches selected from the corn-derived starch and the tapioca-derived starch.

In the present invention, from the viewpoints of better processing suitability, better processing stability over time, and better heat-melting properties, it is preferable to use, among the starches treated with hydroxypropylation, one, or two or more starches selected from a hydroxypropyl starch and a hydroxypropyl distarch phosphate.

As the starch treated with hydroxypropylation in the imitation cheese according to the present invention, one type thereof may be used alone, or two or more types thereof may be used in combination. Two or more starches treated with hydroxypropylation that are produced from the same type of the raw material starch but have different hydroxypropylation degrees may also be used in combination.

From the viewpoints of better processing suitability, better processing stability over time, and better heat-melting properties, the content of the starch treated with hydroxypropylation in the imitation cheese according to the present invention is preferably 1.0% by mass or more, more preferably 1.2% by mass or more, far more preferably 1.4% by mass or more, or 1.5% by mass or more, and the upper limit thereof is preferably 4.0% by mass or less, more preferably 3.5% by mass or less, and far more preferably 3.0% by mass or less. Accordingly, in one embodiment, the content of the ingredient (C) in the imitation cheese according to the present invention is preferably in the range of 1.0 to 4.0% by mass, more preferably in the range of 1.2 to 3.5% by mass, and far more preferably in the range of 1.5 to 3.0% by mass.

From the viewpoint of better heat-melting properties, the ratio of the content of the starch treated with hydroxypropylation (C) to the content of starch in the imitation cheese according to the present invention is preferably 5.0% by mass or more, more preferably 7.0% by mass or more, far more preferably 9.0% by mass or more, or 10.0% by mass or more, and the upper limit thereof is preferably 40.0% by mass or less, more preferably 30.0% by mass or less, and far more preferably 25.0% by mass or less. Accordingly, in one embodiment, the ratio of the content of the ingredient (C) to the content of the starch in the imitation cheese according to the present invention is preferably in the range of 5.0 to 40.0% by mass, more preferably in the range of 7.0 to 30.0% by mass, and far more preferably in the range of 10.0 to 25.0% by mass.

In addition to the better processing stability over time, from the viewpoint of better heat-melting properties, the content of the starch treated with oxidation (B) relative to 1 part by mass of the starch treated with hydroxypropylation (C) in the imitation cheese according to the present invention is preferably 1.5 parts by mass or more, more preferably 2.0 parts by mass or more, far more preferably 2.5 parts by mass or more, 3.0 parts by mass by mass or more, 3.5 parts by mass or more, 4.0 parts by mass or more, or 4.5 parts by mass or more, and the upper limit thereof is preferably 12.0 parts by mass or less, more preferably 10.0 parts by mass or less, and far more preferably 8.0 parts by mass or less. Accordingly, in one embodiment, the content of the ingredient (B) relative to 1 part by mass of the ingredient (C) in the imitation cheese according to the present invention is preferably in the range of 1.5 to 12.0 parts by mass, more preferably in the range of 2.0 to 10.0 parts by mass, and far more preferably in the range of 2.5 to 8.0 parts by mass.

### <Other Starches>

The imitation cheese according to the present invention may contain raw material starches and processed starches other than the starch treated with oxidation (B) and the starch treated with hydroxypropylation (C) (hereinafter, these are also referred to simply as “other starches”).

There is no particular restriction in the processed starch other than the starch treated with oxidation (B) and the starch treated with hydroxypropylation (C) as far as it is the processed starch having not undergone the oxidation treatment or the hydroxypropylation treatment. Examples of the treatment include one, or two or more treatments selected from, other than the oxidation and the hydroxypropylation treatments, physical treatments such as a bleaching treatment and a wet heat treatment, chemical treatments such as an esterification treatment, an etherification treatment, an acetylation treatment, a phosphorylation treatment, a cross-linking treatment, or an emulsification treatment, and an enzymatic treatment applied to a raw material starch.

In the imitation cheese according to the present invention, one, or two or more other starches selected from those described above may be used.

The content of the other starch in the imitation cheese according to the present invention is preferably 10.0% by mass or less, more preferably 8.0% by mass or less, far more preferably 5.0% by mass or less, and especially preferably 3.0% by mass or less. The lower limit of the content of the other starch in the imitation cheese according to the present invention is 0% by mass.

The content of the other starch in the imitation cheese according to the present invention shall also include the amounts of other starches included in (A) the nut and seed and other raw materials to be described later.

### <(D) Fat and Oil>

The imitation cheese according to the present invention contains a fat and oil as the ingredient (D).

The fat and oil used in the imitation cheese according to the present invention is not particularly restricted as far as it satisfies (Condition 1) described below. Examples thereof include vegetable fats and oils such as a palm oil, a palm kernel oil, a coconut oil, a corn oil, a cottonseed oil, a soybean oil, a rapeseed oil, a high erucic acid rapeseed oil, a rice oil, a sesame oil, a peanut oil, a sunflower oil, a high oleic sunflower oil, a safflower oil, a high oleic safflower oil, a canola oil, a kapok oil, an evening primrose oil, an olive oil, shea butter, a sal fat, Kokum butter, illipe butter, and cacao butter; animal fats and oils such as milk fat, beef tallow, pork fat, and a whale oil; and processed fats and oils obtained by subjecting any of these vegetable fats and oils and animal fats and oils to one, or two or more treatments selected from hydrogenation, fractionation, and interesterification. The imitation cheese according to the present invention may contain one, or two or more selected from these fats and oils described above.

In the following, the term “processed fats and oils having been subjected to one, or two or more treatments selected from hydrogenation, fractionation, and interesterification” are simply referred to as “processed fats and oils”.

The hydrogenation, fractionation, and interesterification to produce the above processed fats and oils may be performed by a conventionally known method.

The fractionation may be a solvent fractionation or a dry fractionation.

The interesterification may be performed by using an enzymatic catalyst such as lipase, or using a chemical catalyst such as sodium methoxide. Although a position-specific interesterification or a random interesterification may be used, a random interesterification is preferable in the present invention from the viewpoint of easier production of the imitation cheese having a good processing stability over time and good heat-melting properties.

The same applies to the following hydrogenation, fractionation, and interesterification to produce the processed fats and oils in the present invention.

From the viewpoints of a better taste, better processing stability over time, and better heat-melting properties, the oil content in the imitation cheese according to the present invention is preferably 10.0% by mass or more, more preferably 12.0% by mass or more, and far more preferably 14.0% by mass or more or, 15.0% by mass or more, and the upper limit thereof is preferably 40.0% by mass or less, more preferably 35.0% by mass or less, and far more preferably 30.0% by mass or less. Accordingly, in one embodiment, the content of the oil in the imitation cheese according to the present invention is preferably in the range of 10.0 to 40.0% by mass, more preferably in the range of 12.0 to 35.0% by mass, and far more preferably in the range of 15.0 to 30.0% by mass.

When the nut and seed, the starch treated with oxidation, the starch treated with hydroxypropylation, and other starches described above, and other raw materials to be described later contain an oil component, the oil content in the imitation cheese according to the present invention shall include these oils, in addition to the fat and oil.

Here, the content of a trans fatty acid residue in the fatty acid residue composition of the fat and oil in the imitation cheese according to the present invention is preferably 5.0% by mass or less, more preferably 3.0% by mass or less, and far more preferably 1.0% by mass or less.

### —(Condition 1)—

The imitation cheese according to the present invention needs to satisfy the following (Condition 1).

(Condition 1): a content of a tri-saturated triglyceride formed of solely saturated fatty acid residues having the carbon number of 12 to 22 in a triglyceride composition in an oil phase is in the range of 30.0 to 70.0% by mass.

The term “tri-saturated triglyceride formed of solely saturated fatty acid residues having the carbon number of 12 to 22” in the present invention refers to a triglyceride in which all the three fatty acid residues constituting the triglyceride are the saturated fatty acid residues having the carbon number of 12 to 22.

The saturated fatty acid residues having the carbon number of 12 to 22 include specifically a lauric acid residue, a myristic acid residue, a palmitic acid residue, a stearic acid residue, an arachidic acid residue, and a behenic acid residue. The constituent fatty acid residues of the tri-saturated triglyceride, which is formed of solely the saturated fatty acid residues having the carbon number of 12 to 22, are formed of one type, or two or more types selected from those described above.

In the present invention, hereinafter, the term “saturated fatty acid residue having the carbon number of 12 to 22” will be referred to simply as “S”, and the term “tri-saturated triglyceride formed of solely the saturated fatty acid residues having the carbon number of 12 to 22” will be referred to simply as “SSS.

The imitation cheese according to the present invention with the content of SSS in the range of 30.0 to 70.0% by mass in the triglyceride composition in the oil phase is less sticky during processing, and has a firmness that is easy to shape, and maintains its physical properties over time after production, thereby enabling to have good processing suitability and good processing stability over time. In addition, it is possible to obtain good heat-melting properties, such as moderate melting and stickiness upon heating.

From the viewpoints of better processing stability over time and better heat-melting properties, the content of SSS in the triglyceride composition in the oil phase in the imitation cheese according to the present invention is preferably 32.0% by mass or more, more preferably 35.0% by mass or more, far more preferably 40.0% by mass or more, and the upper limit thereof is preferably 68.0% by mass or less, more preferably 65.0% by mass or less, and far more preferably 60.0% by mass or less.

Accordingly, in one embodiment, the content of SSS in the triglyceride composition in the oil phase is preferably in the range of 32.0 to 68.0% by mass, more preferably in the range of 35.0 to 65.0% by mass, and far more preferably in the range of 40.0 to 60.0% by mass.

The triglyceride composition in the oil phase of the imitation cheese according to the present invention may be measured using any conventionally known method. For example, it may be measured using the method described in “Standard Oil Analysis Test Method 2.4.6.2 (2013) stipulated by the Japan Oil Chemistry Society”.

The same applies to the following method for measuring the triglyceride composition in the oil phase of the imitation cheese according to the present invention and the triglyceride composition in the fat and oil used in the present invention.

### —(Condition 2)—

While satisfying the above-mentioned (Condition 1), the imitation cheese according to the present invention preferably further satisfies (Condition 2) below.

(Condition 2): a content of tri-laurin in the triglyceride composition in the oil phase is in the range of 5.0 to 30.0% by mass.

The term “tri-laurin” in the present invention refers to the triglycerides in which all the three fatty acid residues constituting the triglyceride are formed of the lauric acid residues.

By satisfying (Condition 1) and then (Condition 2), the imitation cheese according to the present invention will not only be afforded with moderate hardness and better processing suitability, but also be less sticky over time after production thereby having better processing stability over time. In addition, the tri-laurin has a lower melting point than other tri-saturated triglycerides of SSS, which allows it to melt moderately upon heating to obtain better heat-melting properties.

From the viewpoints of better processing stability over time and better heat-melting properties of the imitation cheese according to the present invention, in the imitation cheese according to the present invention, the content of the tri-laurin in the triglyceride composition in the oil phase is preferably 5.0% by mass or more, more preferably 8.0% by mass or more, far more preferably 10.0% by mass or more, especially preferably 12.0% by mass or more, and the upper limit thereof is preferably 30.0% by mass or less, more preferably 25.0% by mass or less, far more preferably 24.0% by mass or less, or 22.0% by mass or less, and especially preferably 20.0% by mass or less. Accordingly, in one embodiment, the content of the tri-laurin in the triglyceride composition in the oil phase is preferably in the range of 5.0 to 30.0% by mass, more preferably in the range of 8.0 to 25.0% by mass, far more preferably in the range of 10.0 to 22.0% by mass, and especially preferably in the range of 12.0 to 20.0% by mass.

### —(Condition 3)—

While satisfying the above-mentioned (Condition 1), the imitation cheese according to the present invention preferably satisfies the following (Condition 3). In addition, while satisfying the above-mentioned (Condition 1) and (Condition 2), the imitation cheese according to the present invention further preferably satisfies the following (Condition 3).

(Condition 3): The ratio of the tri-laurin content in the triglyceride composition in the oil phase to the content of the tri-saturated triglycerides formed of solely the saturated fatty acid residues having the carbon number of 12 to 22 in the triglyceride composition in the oil phase (hereinafter, this ratio is sometimes simply referred to as “tri-laurin/SSS”) is in the range of 0.10 to 0.50.

From the viewpoints of better processing suitability, better processing stability over time, and better heat-melting properties, in the imitation cheese according to the present invention, the tri-laurin/SSS is preferably 0.10 or more, more preferably 0.15 or more, far more preferably 0.20 or more, and the upper limit thereof is preferably 0.50 or less, more preferably 0.40 or less, and far more preferably 0.35 or less. Accordingly, in one embodiment, in the imitation cheese according to the present invention, the tri-laurin/SSS is preferably in the range of 0.10 to 0.50, more preferably in the range of 0.15 to 0.40, and far more preferably in the range of 0.20 to 0.35.

### —(Condition 4)—

While satisfying the above-mentioned (Condition 1), the imitation cheese according to the present invention preferably satisfies the following (Condition 4). In addition, while satisfying the above-mentioned (Condition 1), and (Condition 2) or (Condition 3), the imitation cheese according to the present invention more preferably satisfies the following (Condition 4). Furthermore, while satisfying all the above-mentioned (Condition 1) to (Condition 3), the imitation cheese according to the present invention far more preferably satisfies the following (Condition 4).

(Condition 4): The oleoyl dipalmitin content in the triglyceride composition in the oil phase is 3.0% by mass or less.

The term “oleoyl dipalmitin” in the present invention refers to the triglyceride having two palmitic acid molecule residues and one oleic acid molecule residue. There is no restriction in the positional isomers in the oleoyl dipalmitin in the present invention; this refers to all those having (i) the palmitic acid residues at the positions 1 and 3 and the oleic acid residue at the position 2, (ii) the palmitic acid residues at the positions 1 and 2 and the oleic acid residue at the position 3, and (iii) the palmitic acid residues at the positions 2 and 3 and the oleic acid residue at the position 1.

In the imitation cheese according to the present invention, from the viewpoints of resisting to the changes in physical properties over time after production and better processing stability over time, the content of the oleoyl dipalmitin in the triglyceride composition in the oil phase is preferably 3.0% by mass or less, more preferably 1.5% by mass or less, far more preferably 1.0% by mass or less, and especially preferably 0.8% by mass or less. The lower limit value of the oleoyl dipalmitin content in the triglyceride composition in the oil phase is preferably 0.1% by mass or more, more preferably 0.2% by mass or more, and far more preferably 0.3% by mass or more.

In addition, in the imitation cheese according to the present invention, the content of the tri-saturated triglyceride formed of solely the saturated fatty acid residues having the carbon number of 16 to 22 in the triglyceride composition in the oil phase is preferably in the range of 0.1 to 10.0% by mass, more preferably in the range of 0.1 to 7.0% by mass, and far more preferably in the range of 0.1 to 5.0% by mass.

From the viewpoints of making it easy to satisfies the above (Condition 1), preferably one, or two or more of the above (Condition 2) to (Condition 4) in addition to the above (Condition 1), and more preferably all the above (Condition 1) to (Condition 4), and thereby from the viewpoints of better processing suitability, better processing stability over time, and better heat-melting properties, it is preferable that the imitation cheese according to the present invention contains one, or two or more selected from a fat and oil (α) and a fat and oil (β) described below, and it is more preferable to contain both the fats and oils (α) and (β) described below among fats and oils.

### <<Fat and Oil (α)>>

The fat and oil (α) that is preferably used in the imitation cheese according to the present invention is the fat and oil that satisfies the following (Condition α-1).

### —(Condition α-1)—

(Condition α-1): Non-interesterified fat and oil in which the content of SSS in the triglyceride composition is in the range of 40.0 to 70.0% by mass and the tri-laurin/sss is in the range of 0.20 to 0.60.

The term “non-interesterified fat and oil” in the present invention refers to the fat and oil without an interesterification treatment. The fat and oil having treated with one or more treatments selected from hydrogenation and fractionation shall also be regarded as the non-interesterified fat and oil as long as it is not treated with the interesterification.

In the imitation cheese according to the present invention, from the viewpoints of better processing suitability, better processing stability over time, and better heat-melting properties, the content of SSS in the triglyceride composition of the fat and oil (α) is preferably 42.0% by mass or more, more preferably 45.0% by mass or more, and the upper limit thereof is preferably 65.0% by mass or less, and more preferably 60.0% by mass or less. Accordingly, in one embodiment, the content of SSS in the triglyceride composition of the fat and oil (α) is preferably in the range of 42.0 to 65.0% by mass, and more preferably in the range of 45.0 to 60.0% by mass. From the same viewpoints, the tri-laurin/SSS of the fat and oil (α) is preferably 0.25 or more, more preferably 0.30 or more, and the upper limit thereof is preferably 0.55 or less, and more preferably 0.50 or less. Accordingly, in one embodiment, the tri-laurin/SSS of the fat and oil (α) is preferably in the range of 0.25 to 0.55, and more preferably in the range of 0.30 to 0.50.

### —(Condition α-2)—

From the viewpoint of better processing stability over time, the fat and oil (α) preferably used for the imitation cheese according to the present invention is preferably the fat and oil that further satisfies the following (Condition α-2).

(Condition α-2): The content of oleoyl dipalmitin in the triglyceride composition is 3.0% by mass or less.

The content of oleoyl dipalmitin in the triglyceride composition in the fat and oil (α) is preferably 3.0% by mass or less, more preferably 2.5% by mass or less, and far more preferably 2.0% by mass or less. The lower limit of the content of oleoyl dipalmitin in the triglyceride composition in the fat and oil (α) is 0% by mass.

Examples of the fat and oil that is especially preferably used as the fat and oil (α) and satisfies (Condition α-1) and (Condition α-2) include a palm kernel oil, a coconut oil, and a fractionated hard oil of these; one, or two or more selected from them may be used. Among these, it is preferable to use one, or two or more selected from a palm kernel oil and a coconut oil, and a coconut oil is more preferable.

When the imitation cheese according to the present invention contains the fat and oil (α), the content thereof in the fat and oil contained in the imitation cheese according to the present invention is preferably 15.0% by mass or more, more preferably 35.0% by mass or more, far more preferably 50.0% by mass or more, and especially preferably 70.0% by mass or more, and the upper limit thereof may be 100% by mass, and is preferably 95.0% by mass or less, or 90.0% by mass or less. Accordingly, in one embodiment, the content of the fat and oil (α) in the fat and oil contained in the imitation cheese according to the present invention is preferably in the range of 15.0 to 100% by mass, more preferably in the range of 35.0 to 100% by mass, far more preferably in the range of 50.0 to 100% by mass, and especially preferably in the range of 70.0 to 90.0% by mass.

Note that when other raw materials to be described later contain the fat and oil (α), the content of the fat and oil (α) in the imitation cheese according to the present invention shall include this amount.

### <<Fat and Oil (β)>>

The fat and oil (β) that is preferably used in the imitation cheese according to the present invention is the fat and oil that satisfies the following (Condition β-1).

### —(Condition β-1)—

(Condition β-1): An interesterified fat and oil in which the content of SSS in the triglyceride composition is in the range of 40.0 to 80.0% by mass and the tri-laurin/SSS in the triglyceride composition is in the range of 0.01 to 0.25.

The fat and oil (β) is the interesterified fat and oil. In addition to the interesterification, the fat and oil (β) may be treated with one, or two or more treatments selected from hydrogenation and fractionation.

From the viewpoints of better processing stability over time and better heat-melting properties of the imitation cheese according to the present invention, the content of SSS in the triglyceride composition in the fat and oil (β) is preferably 45.0% by mass or more, more preferably 50.0% by mass or more, and the upper limit thereof is preferably 75.0% by mass or less, and more preferably 70.0% by mass or less. Accordingly, in one embodiment, the content of SSS in the triglyceride composition in the fat and oil (β) is preferably in the range of 45.0 to 75.0% by mass, and more preferably in the range of 50.0 to 70.0% by mass. In addition, the tri-laurin/SSS of the fat and oil (β) is preferably 0.20 or less, more preferably 0.18 or less, or 0.16 or less, or 0.15 or less. Accordingly, in one embodiment, the tri-laurin/SSS of the fat and oil (β) is preferably in the range of 0.01 to 0.20, and more preferably in the range of 0.01 and 0.18.

### —(Condition β-2)—

From the viewpoint of better processing stability over time of the imitation cheese according to the present invention, it is preferable that the fat and oil (β) preferably used for the imitation cheese according to the present invention further satisfies the following (Condition β-2).

(Condition β-2): The content of the oleoyl dipalmitin in the triglyceride composition is 2.0% by mass or less.

The content of the oleoyl dipalmitin in the triglyceride composition in the fat and oil (β) is preferably 2.0% by mass or less, more preferably in the range of 0.3 to 2.0% by mass, and far more preferably in the range of 0.5 to 2.0% by mass.

Examples of the fat and oil that satisfies (Condition β-1) and (Condition-2) and is especially preferably used as the fat and oil (β) include an interesterified fat and oil of the fat and oil blend containing a palm-based oil and the fat and oil that contains 25% by mass or more of the lauric acid residue in the fatty acid residue composition in the fat and oil such as a palm kernel oil and a coconut oil; one, or two or more selected from these may be used.

The term “palm-based oil” in the present invention refers to a palm oil and a processed fats and oils of palm oil, such as a palm oil, a palm fractionated soft oil, a palm fractionated medium oil, a palm fractionated hard oil, a partially hydrogenated palm oil, and a fully hydrogenated palm oil, among other oils.

One preferable embodiment of the fat and oil (β) that satisfies (Condition β-1) and (Condition β-2) is the interesterified fat and oil of the fat and oil blend containing 25.0 to 80.0% by mass of a palm kernel oil and 20.0 to 75.0% by mass of a fully hydrogenated palm oil, with 100% by mass as the sum of them.

When the imitation cheese according to the present invention contains the fat and oil (β), its content in the fat and oil contained in the imitation cheese according to the present invention is preferably 5.0% by mass or more, more preferably 10.0% by mass or more, and the upper limit thereof is preferably 85.0% by mass or less, more preferably 65.0% by mass or less, far more preferably 50.0% by mass or less, and especially preferably 30.0% by mass or less. Accordingly, in one embodiment, the content of the fat and oil (β) in the fat and oil contained in the imitation cheese according to the present invention is preferably in the range of 5.0 to 85.0% by mass, more preferably in the range of 5.0 to 65.0% by mass, far more preferably in the range of 5.0 to 50.0% by mass, and especially preferably in the range of 10.0 to 30.0% by mass.

Note that when other raw materials to be described later contain the fat and oil (β), the content of the fat and oil (β) contained in the imitation cheese according to the present invention shall include this amount.

When the imitation cheese according to the present invention contains the fat and oil (α) and the fat and oil (β), the content of the fat and oil (β) per 1 part by mass of the fat and oil (α) is, on the condition that the above-mentioned preferable contents of the fat and oil (α) and the fat and oil (β) are satisfied, preferably 5.0 parts by mass or less, more preferably 3.0 parts by mass or less, far more preferably 2.0 parts by mass or less, especially preferably 1.0 part by mass or less, and the lower limit thereof is preferably 0.1 part by mass or more. Accordingly, in one embodiment, the content of the fat and oil (β) per 1 part by mass of the fat and oil (α) is preferably in the range of 0.1 to 5.0 parts by mass, more preferably in the range of 0.1 to 3.0 parts by mass, far more preferably in the range of 0.1 to 2.0 parts by mass, and especially preferably in the range of 0.1 to 1.0 parts by mass.

### <Water>

It is preferable that the imitation cheese according to the present invention contains water.

Illustrative examples of the water contained in the imitation cheese according to the present invention include water such as tap water and mineral water, as well as moisture contained in the aforementioned nut and seed, oxidized starch, hydroxypropylated starch, other starches, fat and oil, and other raw materials to be described later.

The water content in the imitation cheese according to the present invention is preferably 21.0% by mass or more, more preferably 30.0% by mass or more, far more preferably 40.0% by mass or more, and the upper limit thereof is preferably 70.0% by mass or less, more preferably 65.0% by mass or less, and far more preferably 60.0% by mass or less. Accordingly, in one embodiment, the content of water in the imitation cheese according to the present invention is preferably in the range of 21.0 to 70.0% by mass, more preferably in the range of 30.0 to 65.0% by mass, and far more preferably in the range of 40.0 to 60.0% by mass.

As for the method of measuring the water content in the imitation cheese according to the present invention, any conventionally known method may be used. For example, the water content may be measured by the Karl Fischer method or the like.

When the imitation cheese according to the present invention contains water, it may or may not be emulsified, though preferably emulsified.

There is no particular restriction in the emulsification form; illustrative examples thereof include an oil-in-water type, a water-in-oil-in-water type, a water-in-oil type, an oil-in-water-in-oil type, and an oil-in-oil type. However, from the viewpoints of a better taste, better processing stability over time, and better heat-melting properties, the emulsification form of the oil-in-water type is preferable.

### <Protein>

From the viewpoints of a better taste, better processing suitability, better processing stability over time, and better heat-melting properties, the protein content in the imitation cheese according to the present invention is preferably 0.2% by mass or more, more preferably 0.4% by mass or more, far more preferably 0.5% by mass or more, and the upper limit thereof is preferably 8.0% by mass or less, more preferably 6.0% by mass or less, and far more preferably 5.0% by mass or less. Accordingly, in one embodiment, the content of the protein in the imitation cheese according to the present invention is preferably in the range of 0.2 to 8.0% by mass, more preferably in the range of 0.4 to 6.0% by mass, and far more preferably in the range of 0.5 to 5.0% by mass.

In the imitation cheese according to the present invention, in order to adjust the protein content in the imitation cheese within the above-mentioned suitable range, it is preferable to include the nut and seed as the protein, though more preferably to include a protein material derived from the nut and seed. Among them, it is especially preferable that the preferable content of the protein is satisfied by inclusion of the protein material derived from an almond.

### <Other Raw Materials>

The imitation cheese according to the present invention may contain other raw materials other than the aforementioned nut and seed, starch treated with oxidation, starch treated with hydroxypropylation, other starches, fat and oil, and water, as long as it does not impair the advantageous effects of the present invention.

Examples of the other raw materials include food raw materials and food additives such as a thickening stabilizer, a sugar, a sugar alcohol, a high-sweetness sweetener, salt enhancers such as salt and potassium chloride, pH adjusters such as an organic acid, a seasoning, a spice, an emulsifier, an enzyme, a colorant, a flavoring agent, an antioxidant, a food preservative, a shelf life improver, a fruit and its processed product, a vegetable and its processed product, a meat and its processed product, fish and its processed product, dairy products such as milk, a cheese, and butter, plant milk and its processed product other than those derived from the nut and seed, such as soy milk, oats milk, and rice milk, coffee, cacao mass, cocoa powder, and alcoholic beverages such as wine and liqueur; one, or two or more selected from those described above may be used.

The content of the other raw materials in the imitation cheese according to the present invention is preferably 20.0% by mass or less, more preferably 15.0% by mass or less. The lower limit of the content of the other raw materials is 0% by mass.

Examples of the thickening stabilizer include a guar gum, a locust bean gum, a carrageenan, a gum Arabic, an alginate, a pectin, a xanthan gum, a pullulan, a tamarind seed gum, a psyllium seed gum, a crystal cellulose, carboxymethyl cellulose, methyl cellulose, an agar, and a glucomannan.

In the imitation cheese according to the present invention, from the viewpoints of controlling stickiness and better processing stability over time, it is preferable to contain the thickening stabilizer; and among those described above, it is more preferable to contain one, or two or more thickening stabilizers selected from a guar gum, a locust bean gum, a carrageenan, a pectin, a xanthan gum, a pullulan, an agar, and a glucomannan. It is far more preferable to contain an agar.

When the imitation cheese according to the present invention contains the thickening stabilizer, the content thereof is preferably in the range of 0.1 to 2.0% by mass, more preferably in the range of 0.3 to 1.5% by mass.

Examples of the sugar and sugar alcohol include: sugars such as a monosaccharide, a disaccharide, an oligosaccharide, and a polysaccharides, including a fine white sugar, a triturated sugar, a sucrose, a glucose, a fructose, a lactose, a granulated sugar, molasses, a brown sugar, a maltose, sugar beets, a cane sugar, a powdered sugar, a liquid sugar, an isomerized sugar, an inverted sugar, an enzymatically saccharified syrup, an isomerized syrup, a sucrose-bound syrup, a fructooligosaccharide, a soy oligosaccharide, a galactooligosaccharide, a lactooligosaccharide, a xylose, a trehalose, a raffinose, a lactulose, and a palatinose oligosaccharide; and sugar alcohols such as a sorbitol, a xylitol, a maltitol, an erythritol, a mannitol, a lactitol, a reduced maltose syrup, a reduced lactose, and a reduced sugar syrup.

In the imitation cheese according to the present invention, from the viewpoint of obtaining better heat-melting properties, it is preferable to contain the sugars; in particular, it is more preferable to contain one, or two or more selected from a monosaccharide and a disaccharide, and it is far more preferable to contain a trehalose.

When the imitation cheese according to the present invention contains a sugar and a sugar alcohol, the content thereof in terms of a solid content is preferably in the range of 0.1 to 5.0% by mass, more preferably in the range of 1.0 to 5.0% by mass.

Examples of the high-sweetness sweetener include sodium saccharin, aspartame, potassium acesulfame, a sucralose, a stevia, neotame, a licorice, glycyrrhizin, glycyrrhizinate, dihydrochalcone, thaumatin, and monellin.

<pH>

From the viewpoint of preventing occurrence of an odd taste and obtaining a good cheese-like taste, and the view point of preventing deterioration of processing suitability and obtaining good processing suitability and good processing stability over time, the pH of the imitation cheese according to the present invention needs to be in the range of 3.0 to 6.0.

The pH of the imitation cheese according to the present invention is preferably in the range of 3.3 to 5.8, more preferably in the range of 3.5 to 5.5.

As for the method of measuring the pH of the imitation cheese according to the present invention, any conventionally known method may be used. In the present invention, the pH of the mixture prior to heat treatment may be considered as the pH of the imitation cheese according to the present invention in the producing process of the imitation cheese according to the present invention. Alternatively, the pH of the produced imitation cheese according to the present invention measured using a pH measurement instrument for a food product may be considered as the pH of the imitation cheese according to the present invention.

Specifically, the pH of the mixture before heat treatment and before homogenization may be regarded as the pH of the mixture before heat treatment, or the pH of the mixture after homogenization may be regarded as the pH of the mixture before heat treatment. It is preferable that the measurement of the pH of the mixture before the heat treatment is performed after the temperature of the mixture prior to the heat treatment is adjusted to 20 to 30° C.

In order to bring the pH of the imitation cheese according to the present invention within the above-mentioned preferable numerical range, from the viewpoint of affording the imitation cheese according to the present invention with a better taste, it is preferable to adjust the pH by including an organic acid or a food raw material containing an organic acid, or to adjust the pH by an organic acid fermentation of the mixture in the producing process of the imitation cheese or by an organic acid fermentation of the produced imitation cheese.

There is no particular restriction in the organic acid that may be used to adjust the pH of the imitation cheese according to the present invention as far as it is an edible organic acid; examples thereof include adipic acid, citric acid, gluconic acid, succinic acid, acetic acid, tartaric acid, lactic acid (including fermented lactic acid), fumaric acid, malic acid, phosphoric acid, and phytic acid.

Examples of the food raw material containing the organic acid that may be used to adjust the pH of the imitation cheese according to the present invention include: fruits such as an orange, a strawberry, a grape, a lemon, a pineapple, an apple, as well as juices of these fruits; food raw materials such as a cheese, fermented milk, vinegar, and coffee; and processed products such as a paste, puree, and jam of these foods.

The imitation cheese according to the present invention may contain one, or two or more selected from organic acids and food raw materials containing an organic acid. The content of the organic acid or the food raw material containing the organic acid in the imitation cheese according to the present invention may be adjusted as appropriate so as to meet the above-mentioned preferable pH range. It is preferable, for example, that the imitation cheese according to the present invention contains 0.2 to 1.5% by mass of lactic acid, although the amount varies depending on the type of the organic acid contained therein.

### <Characteristics and Application of Imitation Cheese According to the Present Invention>

The imitation cheese according to the present invention is characterized by a good taste, moderate firmness, good processing suitability, and good heat-melting properties.

Therefore, the imitation cheese according to the present invention may be preferably used as a cheese substitute. Among many types of cheeses, this may be used more preferably as the substitute especially for a semi-hard cheese, a hard cheese, and an ultra-hard cheese.

In general, examples of the semi-hard cheese include a Gorgonzola cheese, a Roquefort cheese, and a Gouda cheese. Examples of the hard cheese include an Emmental cheese, a Cheddar cheese, and an Edam cheese. Examples of the ultra-hard cheese include a Parmigiano Reggiano cheese and a Romano cheese.

In addition, the imitation cheese according to the present invention is characterized by its good processing suitability, because it does not crumble, generate shavings or powder, or become sticky, when processed, for example, by shredding into strips or cutting into dices. In addition, unlike conventional imitation cheeses produced from proteins derived from legumes or cereals, or from a starch as the skeleton, the imitation cheese according to the present invention is also characterized by small changes in physical properties even after a lapse of time since production, and good processing stability over time.

Therefore, the imitation cheese according to the present invention may be preferably used as the substitute for processed cheeses, such as specifically a shredded cheese, a diced cheese, a sliced cheese, and a powdered cheese.

### [Method for Producing Imitation Cheese According to the Present Invention]

Next, the method for producing the imitation cheese according to the present invention will be described (hereinafter, this is also simply referred to as the “production method of the present invention”).

The production method of the present invention is a method for producing an imitation cheese, containing (A) a nut and seed, (B) a starch treated with oxidation, (C) a starch treated with hydroxypropylation, and (D) a fat and oil, satisfying (Condition 1) below, and having a pH of 3.0 to 6.0, and the method including (Step 1) to (Step 5) below:
(Condition 1): a content of a tri-saturated triglyceride formed of solely saturated fatty acid residues having the carbon number of 12 to 22 in a triglyceride composition in an oil phase is in the range of 30.0 to 70.0% by mass;
(Step 1): a step of obtaining a mixture that contains the ingredients (A) to (D) described above and satisfies (Condition 1);
(Step 2): a step of adjusting a pH of the mixture to 3.0 to 6.0;
(Step 3): a step of homogenizing the mixture;
(Step 4): a step of heating the pH-adjusted mixture to 80° C. or higher; and
(Step 5); a step of cooling the mixture having been heated to 80° C. or higher to 20° C. or lower.

The raw materials (A) through (D), (Condition 1), and the imitation cheese obtained by the production method of the present invention have already described before.

Hereinafter, a preferable production method of the imitation cheese that takes the emulsification form of an oil-in-water type, which is a preferable embodiment of the imitation cheese according to the present invention, will be described.

### <With Regard to (Step 1)>

(Step 1) is the step of obtaining a mixture that contains all the ingredients (A) through (D) described above and satisfies (Condition 1) described above (hereinafter, this is also referred to as simply “mixture preparation step”).

(Step 1) is the step of obtaining preferably a mixture that contains all the ingredients (A) through (D) and satisfies (Condition 1), and one, or two or more of (Condition 2) through (Condition 4), or more preferably a mixture that contains all the ingredients (A) through (D) and satisfies all the (Condition 1) through (Condition 4).

Specifically, the heat-melted fat and oil is mixed with the nut and seed, the starch treated with hydroxypropylation, and, if necessary, other raw materials of the imitation cheese according to the present invention, to obtain an oil phase that satisfies (Condition 1), preferably an oil phase that satisfies (Condition 1), and one, or two or more of (Condition 2) to (Condition 4), or more preferably an oil phase that satisfies all the (Condition 1) to (Condition 4).

Also an aqueous phase is obtained by mixing preferably heated water, with the starch treated with oxidation, and if necessary, other raw materials of the imitation cheese according to the present invention.

The oil phase is added to the obtained aqueous phase and mixed together, and then the resulting mixture is emulsified to obtain a mixture in the emulsification form of an oil-in-water type.

From the viewpoint of avoiding thickening and of increasing the production efficiency, the liquid temperature of the mixture is made preferably in the range of 45 to 75° C., though this temperature varies depending on, among others, the melting point of the fat and oil that is contained therein.

### <With Regard to (Step 2)>

(Step 2) is the step of adjusting the pH of the mixture obtained at the mixture preparation step to 3.0 to 6.0 (hereinafter this step is also simply referred to as the “pH adjusting step”).

In the production method of the present invention, the pH adjusting step in (Step 2) may be performed before or after (Step 3) described below. When the pH adjusting step is performed after (Step 3), the pH adjusting step in the production method of the present invention is the step of adjusting the pH of the homogenized mixture to 3.0 to 6.0.

As for the method of adjusting the pH of the mixture within the numerical range of the preferable pH of the imitation cheese according to the invention as described before, from the viewpoint of a better taste of the imitation cheese obtained by the production method of the present invention, it is preferable to adjust the pH by including an organic acid or a food raw material containing an organic acid, or by an organic acid fermentation of the mixture. From the viewpoint of adjusting the pH more conveniently, it is more preferable to adjust the pH by including an organic acid or a food raw material containing an organic acid.

The organic acid or the food raw material containing the organic acid that may be used in the production method of the present invention have already described in relation to pH adjustment of the imitation cheese according to the present invention.

### <With Regard to (Step 3)>

(Step 3) is the step of homogenizing the mixture (hereinafter this is also simply referred to as the “homogenizing step”).

In the production method of the present invention, the homogenizing step (Step 3) may be performed before or after the aforementioned pH adjusting step. When the homogenizing step is performed after (Step 2), the homogenizing step in the production method of the present invention is the step of homogenizing the mixture having the pH thereof adjusted between 3.0 and 6.0. When the homogenizing step is performed before (Step 2), the homogenizing step in the production method of the present invention is the step of homogenizing the mixture obtained at the mixture preparation step.

Homogenization at the homogenizing step may be performed by any conventionally known method. For example, the homogenization may be performed by a homogenizer such as a valve homogenizer, a homo-mixer, or a colloid mill.

Although the homogenization pressure is not particularly restricted, it is preferably in the range of 0 to 200 MPa. When the homogenization is performed using a two-stage homogenizer, for example, the first stage is preferably performed at the pressure in the range of 1 to 150 MPa and the second stage in the range of 3 to 200 MPa.

### <With Regard to (Step 4)>

(Step 4) is the step of heating the pH-adjusted mixture to 80° C. or higher (hereinafter, this step is also simply referred to as the “heating treatment step”).

By heating the mixture to 80° C. or higher. the imitation cheese with a good taste, good processing suitability, and good processing stability over time may be obtained more readily.

The heat treatment in the heating treatment step may be performed by any conventionally known method. Examples thereof include heating treatment by UHT and HTST using direct heating methods such as injection type and inflation type or using indirect heating methods such as plate type, tubular type, and scraping type, and heating treatment by batch-type, retort, microwave heating and the like, or heating treatment by direct fire.

From the viewpoints of a better taste, better processing suitability, and better processing stability over time of the imitation cheese to be produced, the temperature of the heat treatment is preferably 80° C. or higher, more preferably in the range of 90 to 150° C., and far more preferably in the range of 100 to 140° C. The heating time is preferably in the range of 1 second to 15 minutes, though these values may vary depending on the heating temperature.

### <With Regard to (Step 5)>

(Step 5) is the step of cooling the mixture, having been heated to 80° C. or higher at the heating treatment step, to 20° C. or lower (hereinafter, this step is also simply referred to as the “cooling step”).

By cooling the mixture, having been heated to 80° C. or higher, to 20° C. or lower, it becomes easier to produce the imitation cheese having a good taste, good processing suitability, good processing stability over time, and good heat-melting properties.

At the cooling step, the cooling is performed to the temperature of preferably 20° C. or lower, more preferably 15° C. or lower, and far more preferably 10° C. or lower. The lower limit of the cooling temperature is not particularly restricted as long as it is within the temperature range where the cooling may be performed; it is preferably 0° C. or higher, more preferably 2° C. or higher.

Cooling at the cooling step may be performed any of a rapid cooling and a slow cooling. In the production method of the present invention, a slow cooling is preferable.

In the present invention, the rapid cooling refers to the cooling with a cooling rate of 1.0° C./min or more, and the slow cooling refers to the cooling with a cooling rate of less than 1.0° C./min.

By performing through the above (Step 1) to (Step 5), the imitation cheese according to the present invention, which takes the emulsification form of an oil-in-water type, may be obtained.

The imitation cheese according to the present invention having been produced in the manner described above may be arbitrarily shaped into a block, a bar, a cylinder, a dice, a shred, a sheet, a spherical shape, and the like. Preferable sizes for each shape are: a block shape with a longitudinal dimension of 50 to 1000 mm, a lateral dimension of 50 to 1000 mm, and a thickness of 50 to 500 mm; a bar shape with a longitudinal dimension of 1 to 25 mm, a lateral dimension of 1 to 25 mm, and a length of 5 to 100 mm; a cylindrical shape with diameter of 1 to 25 mm and a length of 5 to 100 mm; a dice shape with a longitudinal dimension of 5 to 50 mm, a lateral dimension of 5 to 50 mm, and a thickness of 5 to 50 mm; a shred shape with a diameter of 1 to 25 mm and a length of 5 to 100 mm; a sheet shape with a longitudinal dimension of 50 to 1000 mm, a lateral dimension of 50 to 1000 mm, and a thickness of 1 to 50 mm; and a spherical shape with a diameter of 10 to 500 mm.

In addition, the imitation cheese according to the present invention may be packed or packaged in a container, a bag, or the like having an arbitrary shape. The resulting imitation cheese according to the present invention may be stored frozen, refrigerated, or at room temperature. The frozen storage in the present invention means the storage at the temperature lower than 0° C., preferably at the temperature of −40° C. or higher and lower than 0° C. The refrigerated storage means the storage at the temperature of 0° C. or higher and lower than 10° C. The room temperature storage means the storage at the temperature range of 10 to 30° C., preferably 10 to 20° C.

The period of storage is not particularly restricted as long as it is a period during which the product may be safely consumed, but from the viewpoint of achieving sufficient processing stability over time, the period is preferably in the range of 0 to 180 days, more preferably in the range of 0 to 150 days, and far more preferably in the range of 0 to 120 days.

The resulting imitation cheese according to the present invention may be processed into any shape after the frozen storage, the refrigerated storage, or the room temperature storage.

The imitation cheese obtained by the production method according to the present invention has good processing stability over time, so that it does not crumble, generate shavings or powder, or become sticky, after the frozen, the refrigerated, or the room temperature storage, and may be suitably processed.

### [Food Product Containing the Imitation Cheese According to the Present Invention]

Finally, the food product according to the present invention will be described. The food product according to the present invention contains the imitation cheese according to the present invention.

Specifically, the food product may consist solely of the imitation cheese according to the invention, or may be in a combination of the imitation cheese according to the present invention with other food raw materials.

There is no particular restriction in other food raw material that may be combined with the imitation cheese according to the present invention. There is no particular restriction in the method for combining the imitation cheese according to the present invention with other food raw material. For example, the imitation cheese according to the present invention may be used as it is, or it may be shredded into strips, diced, grated into powder, or otherwise processed, and then topped on other food raw material, sprinkled, mixed with other food raw material; or alternatively, the imitation cheese according to the present invention may be made into a paste to be used for filling, topping, or dipping, so that this may be combined with other food raw materials.

When combining the imitation cheese according to the present invention with other food raw material, the resulting food product is preferably those that may be produced using the imitation cheese according to the present invention as the cheese substitute. Examples of the food product in which the imitation cheese according to the present invention may be used as a cheese substitute include toast, pastry, cake, tart, pizza, gratin, doria, lasagna, hamburger, risotto, cheese fondue, dressing, and sauce.

### EXAMPLES

Hereinafter, the present invention will be described in more detail with reference to Examples. However, the present invention is not limited to Examples described below.

### [Fat and Oil Used]

### <Coconut Oil>

In the triglyceride composition, the content of SSS was 55.8% by mass, the content of tri-laurin was 20.9% by mass, and the content of oleoyl dipalmitin was 0.4% by mass.

Note that this coconut oil corresponds to the aforementioned fat and oil (α).

### <Palm Fractionated Medium Oil>

In the triglyceride composition, the content of SSS was 2.9% by mass, the content of tri-laurin was 0.3% by mass, and the content of oleoyl dipalmitin was 63.1% by mass; and the iodine value was 35.

Note that this palm fractionated medium oil does not fall under the fat and oil (α) nor the fat and oil (β) described before.

### <Interesterified Fat and Oil (1)>

A fat and oil blend including 50 parts by mass of a palm kernel oil and 50 parts by mass of a fully hydrogenated palm oil was subjected to a random interesterification reaction using sodium methoxide as a catalyst, followed by refining with a conventional method to obtain an interesterified fat and oil (1).

In the triglyceride composition of the interesterified fat and oil (1), the content of SSS was 66.9% by mass, the content of tri-laurin was 2.3% by mass, and the content of oleoyl dipalmitin was 1.3% by mass.

Note that this interesterified fat and oil (1) corresponds to the fat and oil (β) described before.

### <Interesterified Fat and Oil (2)>

A fat and oil blend including 75 parts by mass of a palm kernel oil and 25 parts by mass of a fully hydrogenated palm oil was subjected to a random interesterification reaction using sodium methoxide as a catalyst, followed by refining with a conventional method to obtain an interesterified fat and oil (2).

In the triglyceride composition of the interesterified fat and oil (2), the content of SSS was 55.1% by mass, the content of tri-laurin was 7.0% by mass, and the content of oleoyl dipalmitin was 0.8% by mass.

Note that this interesterified fat and oil (2) corresponds to the fat and oil (β) described before.

One type of the fats and oils described above was used alone, or two or more types thereof were used in combination. The compositions of the fats and oils D1 to D5 used in Examples and Comparative Examples are described in Table 1.

### [Table 1]

TABLE 1

Fat and oil

| (% by mass) | D1 | D2 | D3 | D4 | D5 |
|---|---|---|---|---|---|
| Coconut oil | 85 | 100 | 40 | 20 | |
| Palm fractionated | | | | | 100 |
| medium oil | | | | | |
| Interesterified | 15 | | 39 | 52 | |
| fat and oil (1) | | | | | |
| Interesterified | | | 21 | 28 | |
| fat and oil (2) | | | | | |

### [Plant-Derived Raw Materials Used]

### <Almond-Derived Protein Material (1)>

The powdered protein obtained by defatting the dehulled almonds followed by concentrating and powdering the protein thereby obtained was used.

The content of the oil was 11.8% by mass, the content of the protein was 44.4% by mass, the content of the carbohydrate was 32.8% by mass, and the content of moisture was 5.0% by mass.

### <Almond-Derived Protein Material (2)>

The powdered protein obtained by defatting the dehulled almonds followed by concentrating and powdering the protein thereby obtained was used.

The content of the oil was 23.0% by mass, the content of the protein was 39.1% by mass, the content of the carbohydrate was 28.6% by mass, and the content of moisture was 5.0% by mass.

### <Powdered Almond>

Powdered dehulled almonds were used.

The content of the oil was 54.2% by mass, the content of the protein was 18.6% by mass, the content of the carbohydrate was 19.7% by mass, and the content of moisture was 4.6% by mass.

### <Soybean-Derived Protein Material>

Powdered isolated soybean protein was used.

The content of the oil was 3.0% by mass, the content of the protein was 80.7% by mass, the content of the carbohydrate was 7.7% by mass, and the content of moisture was 6.0% by mass.

### <Powdered Chickpea>

Powdered steam-heated chickpeas were used.

The content of the oil was 7.0% by mass, the content of the protein was 20.0% by mass, the content of the carbohydrate was 65.0% by mass, and the content of moisture was 5.0% by mass.

### [Starch Used]

### <Oxidized Starch>

Potato-derived raw material starch treated with oxidation was used.

This oxidized starch corresponds to the starch treated with oxidation in the present invention.

### <Hydroxypropyl Distarch Phosphate>

Corn-derived raw material starch treated with hydroxypropylation and with crosslinking by phosphoric acid was used.

This hydroxypropyl distarch phosphate corresponds to the starch treated with hydroxypropylation in the present invention.

### <Hydroxypropyl Starch>

The tapioca-derived raw material starch treated with hydroxypropylation was used.

This hydroxypropyl starch corresponds to the starch treated with hydroxypropylation in the present invention.

### [Study 1]

Plant-derived raw materials used in the imitation cheese were studied.

Imitation cheeses of Examples 1 to 5 and Comparative Examples 1 to 3 were produced in accordance with the formulations in Table 2 by the following production method.

### <Method for Producing Imitation Cheese>

Except for the imitation cheese in Comparative Example 1, to the fats and oils D1 were added any one of the almond-derived protein raw material (1), the almond-derived protein raw material (2), the powdered almond, the soybean-derived protein material, and the powdered chickpea, as well as the hydroxypropyl distarch phosphate, and pectin; then, the resulting mixture was stirred to obtain an oil phase. With regard to the imitation cheese in Comparative Example 1, the hydroxypropyl distarch phosphate and pectin were added to the blended fat and oil; and then the resulting mixture was stirred and mixed to obtain an oil phase.

Next, the oxidized starch, salt, potassium chloride, sodium glutamate, a trehalose, and an agar were added to water, and stirred and mixed to obtain an aqueous phase.

To the aqueous phase, the oil phase was added and mixed, and then the resulting mixture was emulsified to obtain a mixture in the emulsification form of an oil-in-water type. To the obtained mixture, 50%-fermented lactic acid (fermented lactic acid containing 50% of lactic acid) was added to adjust to the pH as described in Table 2; then, the mixture was homogenized under a homogenization pressure of 3 MPa.

The resulting homogenized mixture was heated with a direct-heating UHT sterilizer at 120° C. for 3 seconds, followed by slow cooling to 4° C. to obtain the respective imitation cheeses of Examples 1 to 5 and Comparative Examples 1 to 3.

TABLE 2

| | | | | | | | Com- | Com- | Com- |
|---|---|---|---|---|---|---|---|---|---|
| | | Exam- | Exam- | Exam- | Exam- | Exam- | parative | parative | parative |
| | | ple 1 | ple 2 | ple 3 | ple 4 | ple 5 | Example 1 | Example 2 | Example 3 |
| (A) | Almond-derived protein material (1) | 2 | | | 1 | 4 | | | |
| | Almond-derived protein material (2) | | 2 | | | | | | |
| | Powdered almond | | | 4 | | | | | |
| (A′) | Soybean-derived protein material | | | | | | | 2 | |
| | Powdered chickpea | | | | | | | | 4 |
| (B) | Oxidized starch | 16.3 | 16.3 | 16.3 | 16.3 | 16.3 | 16.3 | 16.3 | 16.3 |
| (C) | Hydroxypropyl distarch phosphate | 2.5 | 2.5 | 2.5 | 2.5 | 2.5 | 2.5 | 2.5 | 2.5 |
| (D) | Fat and off D1 | 22.5 | 22.5 | 22.5 | 22.5 | 22.5 | 22.5 | 22.5 | 22.5 |
| Salt | | 2 | 2 | 2 | 2 | 2 | 2 | 2 | 2 |
| Potassium chloride | | 0.12 | 0.12 | 0.12 | 0.12 | 0.12 | 0.12 | 0.12 | 0.12 |
| Sodium glutamate | | 0.3 | 0.3 | 0.3 | 0.3 | 0.3 | 0.3 | 0.3 | 0.3 |
| Trehalose | | 3 | 3 | 3 | 3 | 3 | 3 | 3 | 3 |
| Agar | | 0.3 | 0.3 | 0.3 | 0.3 | 0.3 | 0.3 | 0.3 | 0.3 |
| Pectin | | 0.3 | 0.3 | 0.3 | 0.3 | 0.3 | 0.3 | 0.3 | 0.3 |
| 50%-fermented lactic acid | | 0.6 | 0.6 | 0.6 | 0.4 | 0.7 | 0.2 | 0.6 | 0.7 |
| Water | | 50.08 | 50.08 | 48.08 | 51.28 | 47.98 | 52.48 | 50.08 | 47.98 |
| Triglyceride | SSS content (% by mass) | 57.5 | 57.5 | 57.5 | 57.5 | 57.5 | 57.5 | 57.5 | 57.5 |
| composition | Tri-laurin content (% by mass) | 18.1 | 18.1 | 18.1 | 18.1 | 18.1 | 18.1 | 18.1 | 18.1 |
| in oil | Tri-laurin/SSS | 0.32 | 0.32 | 0.32 | 0.32 | 0.32 | 0.32 | 0.32 | 0.32 |
| phase*1 | Oleoyl dipalmitin content | 0.6 | 0.6 | 0.6 | 0.6 | 0.6 | 0.6 | 0.6 | 0.6 |
| | (% by mass) | | | | | | | | |
| | Tri-saturated fatty acid triglyceride | 2.1 | 2.1 | 2.1 | 2.1 | 2.1 | 2.1 | 2.1 | 2.1 |
| | consisting of solely saturated fatty | | | | | | | | |
| | acid residues having the carbon | | | | | | | | |
| | number of 16 to 22 content | | | | | | | | |
| | (% by mass) | | | | | | | | |

| | | | | | | | | |
|---|---|---|---|---|---|---|---|---|
| Oil content (% by mass) | 22.8 | 23.0 | 24.6 | 22.7 | 23.0 | 22.6 | 22.6 | 22.8 |
| Water content (% by mass) | 53.7 | 53.7 | 51.8 | 54.8 | 51.8 | 55.8 | 53.7 | 51.6 |
| Protein content in imitation cheese (% by mass) | 1.0 | 1.0 | 0.9 | 0.8 | 1.9 | 0.2 | 1.8 | 0.9 |
| p H | 4.1 | 4.1 | 4.1 | 4.1 | 4.1 | 4.1 | 4.1 | 4.1 |

*¹S represents a saturated fatty acid residue having the carbon number of 12 to 22, and SSS represents tri-saturated triglyceride consisting of solely saturated fatty acid residues having the carbon number of 12 to 22.

### <Evaluation Method>

The resulting imitation cheese was evaluated for the processing suitability, the processing stability over time, the taste, and the heat-melting properties by using the following evaluation methods. The evaluation results are summarized in Table 3. The imitation cheese with the evaluation results of equal to or better than ∘ in all the evaluation items is considered to be an acceptable product.

### —Evaluation of Processing Suitability—

After the resulting imitation cheese was stored in a refrigerator at 4° C. for 1 day, this was processed into strips (8 mm wide, 30 mm long, 2 mm thick) using a cheese dicer (“cheesixx”: manufactured by holac Maschinenbau GmbH); the processing suitability was evaluated according to the following evaluation criteria.

### —Evaluation Criteria of Processing Suitability—

⊚: Processable; there was almost no collapse of the strip shape and no adhesion to the dicer and no adhesion between the imitation cheeses were observed. The processing suitability was very good.
∘+: Processable; partial collapse of the strip shape was observed, but the processing suitability was good. Or, partial adhesion to the dicer and partial adhesion between the imitation cheeses were observed, but the processing suitability was good.
∘: Processable; widespread collapse of the strip shape was observed, but the processing suitability was still acceptable. Or, adhesion to the dicer and adhesion between the imitation cheeses were widely observed, but the processing suitability was still acceptable.
Δ: Processable, but it was difficult to obtain the imitation cheese in the strip shape due to severe collapse of the strip shape. The processing suitability was poor. Or, it was difficult to obtain the imitation cheese in the strip shape due to severe adhesion to the dicer and severe adhesion between the imitation cheeses. The processing suitability was poor.
x: Hardness was insufficient to perform the processing itself.

### —Evaluation of Processing Stability Over Time—

After the imitation cheese that received a rating of other than x in the above evaluation for processing suitability was stored at 4° C. in a refrigerator for 60 days, this was processed into strips (8 mm wide, 30 mm long, 2 mm thick) using a cheese dicer (“cheesixx” manufactured by holac Maschinenbau GmbH) and evaluated for processing suitability according to the following evaluation criteria.

### —Evaluation Criteria of Processing Stability Over Time—

⊚: The product was still processable after 60 days of storage, and there was almost no collapse of the strip shape and no adhesion to the dicer and no adhesion between the imitation cheeses were observed. The processing stability over time was very good.
∘+: The product was still processable after 60 days of storage, and although partial collapse of the strip shape was observed, the processing stability over time was good. Or, partial adhesion to the dicer and partial adhesion between the imitation cheeses were observed, but the processing stability over time was good.
∘: The product was still processable after 60 days of storage, and although widespread collapse of the strip shape was observed, the processing stability over time was still acceptable. Or, adhesion to the dicer and adhesion between the imitation cheeses were widely observed, but the processing stability over time was still acceptable.
Δ: Although the processing was still possible after 60 days of storage, it was difficult to obtain the imitation cheese in the strip shape due to severe collapse of the strip shape. The processing stability over time was poor. Or, it was difficult to obtain the imitation cheese in the strip shape due to severe adhesion to the dicer and severe adhesion between the imitation cheeses. The processing stability over time was poor.
x: After storage for 60 days, the hardness was insufficient or the shape collapsed due to brittleness; thus, processing itself was impossible.

### —Evaluation of Taste—

Five skilled panelists tasted the imitation cheese that received the rating other than x in the above evaluation for processing suitability. They scored the taste according to the following evaluation criteria, and the evaluation was made based on the total score. Prior to the evaluation, the panelists harmonized their degree of senses in each score.

### —Evaluation Criteria of Taste—

5 points: An odd taste was not felt at all with a rich and very good taste felt.
4 points: An odd taste was not felt at all with a slightly rich and good taste felt.
3 points: An odd taste was slightly felt; the taste was just enough to not be a problem.
2 points: An odd taste was felt, and the taste was poor.
1 point: An odd taste was strongly felt, and the taste was very poor.

⊚: Total score is between 23 and 25 points.

∘+: The total score is between 20 and 22 points.
∘: The total score is between 16 and 19 points.
Δ: Total score is between 11 and 15 points.
x: The total score is between 5 and 10 points.

### —Evaluation of Heat-Melting Properties—

The imitation cheese that received a rating of other than x in the evaluation for the processing suitability described above, was processed into strips (8 mm width, 30 mm long, 2 mm thickness) using a cheese dicer (“cheesixx” manufactured by holac Maschinenbau GmbH).

Fifty grams of the imitation cheese having been processed into strips was evenly topped on a pizza dough of 21 cm in diameter, and then, this was baked in an oven at 250° C. for 5 minutes. The state of melting of the heated imitation cheese was visually observed, and evaluated in accordance with the following evaluation criteria.

### —Evaluation Criteria of Heat-Melting Properties—

⊚: The imitation cheese was melted without maintaining its original shape, and had appropriate viscosity and fluidity. The heat-melting properties were very good.
∘+: The imitation cheese was melted to the extent that the original shape was slightly recognizable with moderate viscosity and fluidity. The heat-melting properties were good.
∘: The imitation cheese was melted to the extent that the original shape was partially recognizable with some fluidity. The heat-melting properties were acceptable.
Δ: The imitation cheese was melted only to the extent that the original shape was recognizable in its entirety with a little fluidity. The heat-melting properties were poor.
x: The original shape of the imitation cheese was maintained without fluidity recognizable. The heat-melting properties were very poor.

TABLE 3

| | | | | | | Com- | Com- | Com- |
|---|---|---|---|---|---|---|---|---|
| | Exam- | Exam- | Exam- | Exam- | Exam- | parative | parative | parative |
| | ple 1 | ple 2 | ple 3 | ple 4 | ple 5 | Example 1 | Example 2 | Example 3 |
| Processing suitability | ⊚ | ⊚ | ⊚ | ◯+ | ⊚ | — | ◯ | ◯+ |
| Processing stability over time | ⊚ | ⊚ | ⊚ | ◯+ | ⊚ | | Δ | Δ |
| Flavor | ⊚ | ⊚ | ◯+ | ⊚ | ◯+ | | X | ◯+ |
| Heat-melting properties | ⊚ | ⊚ | ⊚ | ⊚ | ◯+ | | ◯ | Δ |

### <Results of Study 1>

The imitation cheeses in Examples 1 to 5, which used the nuts and seeds as the plant-derived raw materials, had good processing suitability, good processing stability over time, a good taste, and good heat-melting properties.

On the contrary, as for the imitation cheese in Comparative Example 1, which did not contain the plant-derived raw material, the mixture was not emulsified and the imitation cheese itself failed to be produced.

The imitation cheese in Comparative Example 2, in which soybean-derived protein material was used instead of the nut and seed, had a strong soybean-derived odd taste and the taste was very poor, and on top of it, the imitation cheese was brittle and collapsed when processed after 60 days of storage, thereby showing a poor processing stability over time.

The imitation cheese in Comparative Example 3, which used the powdered chickpea instead of the nut and seed, had a good taste, but its physical properties changed to harder after 60 days of storage, and widespread collapse was observed during processing, and in addition, its heat-melting properties were poor.

Therefore, it was recognized that the nut and seed is needed to acquire the advantageous effects of the present invention.

From the results of Examples 1 to 3, it was also recognized that the lower the oil content in the nut and seed, the better the taste of the imitation cheese. Furthermore, from the results of Example 1 and Examples 4 and 5, it was recognized that there is a preferable numerical range in the content of the nut and seed.

### [Study 2]

The starch treated with oxidation and the starch treated with hydroxypropylation, both being used for the imitation cheese, were studied.

In accordance with the formulation in Table 4, the same procedure was followed in the method of producing the imitation cheese in Study 1, except that the amounts of the oxidized starch and of the hydroxypropyl distarch phosphate were varied, or the hydroxypropyl distarch phosphate was replaced with the hydroxypropyl starch, to produce the imitation cheeses of Examples 6 to 8 and Comparative Examples 4 and 5.

TABLE 4

| | | (Reference) | | | | Comparative | Comparative |
|---|---|---|---|---|---|---|---|
| | | Example 1 | Example 6 | Example 7 | Example 8 | Example 4 | Example 5 |
| (A) | Almond-derived protein material (1) | 2 | 2 | 2 | 2 | 2 | 2 |
| (B) | Oxidized starch | 16.3 | 16.3 | 16.3 | 16.3 | | 16.3 |
| (C) | Hydroxypropyl distarch phosphate | 2.5 | 1 | 4 | | 2.5 | |
| | Hydroxypropyl starch | | | | 2.5 | | |
| (D) | Fat and oil D1 | 22.5 | 22.5 | 22.5 | 22.5 | 22.5 | 22.5 |
| Salt | | 2 | 2 | 2 | 2 | 2 | 2 |
| Potassium chloride | | 0.12 | 0.12 | 0.12 | 0.12 | 0.12 | 0.12 |
| Sodium glutamate | | 0.3 | 0.3 | 0.3 | 0.3 | 0.3 | 0.3 |
| Trehalose | | 3 | 3 | 3 | 3 | 3 | 3 |
| Agar | | 0.3 | 0.3 | 0.3 | 0.3 | 0.3 | 0.3 |
| Pectin | | 0.3 | 0.3 | 0.3 | 0.3 | 0.3 | 0.3 |
| 50%-fermented lactic acid | | 0.6 | 0.6 | 0.6 | 0.6 | 0.6 | 0.6 |
| Water | | 50.08 | 51.58 | 48.58 | 50.08 | 68.38 | 52.58 |
| Triglyceride | SSS content (% by mass) | 57.5 | 57.5 | 57.5 | 57.5 | 57.5 | 57.5 |
| composition | Tri-laurin content (% by mass) | 18.1 | 18.1 | 18.1 | 18.1 | 18.1 | 18.1 |
| in oil | Tri-laurin/SSS | 0.32 | 0.32 | 0.32 | 0.32 | 0.32 | 0.32 |
| phase*1 | Oleoyl dipalmitin content | 0.6 | 0.6 | 0.6 | 0.6 | 0.6 | 0.6 |
| | (% by mass) | | | | | | |
| | Tri-saturated fatty acid triglyceride | 2.1 | 2.1 | 2.1 | 2.1 | 2.1 | 2.1 |
| | consisting of solely saturated fatty | | | | | | |
| | acid residues having the carbon | | | | | | |
| | number of 16 to 22 content | | | | | | |
| | (% by mass) | | | | | | |

| | | | | | | |
|---|---|---|---|---|---|---|
| Oil content (% by mass) | 22.8 | 22.8 | 22.8 | 22.8 | 22.8 | 22.8 |
| Water content (% by mass) | 53.7 | 55.0 | 52.5 | 53.7 | 68.1 | 55.9 |
| Protein content in imitation cheese (% by mass) | 1.0 | 1.0 | 1.0 | 1.0 | 1.0 | 1.0 |
| p H | 4.1 | 4.1 | 4.1 | 4.1 | 4.1 | 4.1 |

%1S represents a saturated fatty acid residue having the carbon number of 12 to 22, and SSS represents tri-saturated triglyceride consisting of solely saturated fatty acid residues heving the carbon number of 12 to 22.

### <Evaluation Method>

The resulting imitation cheeses were evaluated for the processing suitability, the processing stability over time, the taste, and the heat-melting properties, by using the same evaluation methods as in Study 1. The evaluation results are summarized in Table 5. The imitation cheese with the evaluation results of equal to or better than ∘ in all the evaluation items is considered to be an acceptable product.

TABLE 5

| | (Reference) | | | | Comparative | Comparative |
|---|---|---|---|---|---|---|
| | Example 1 | Example 6 | Example 7 | Example 8 | Example 4 | Example 5 |
| Processing suitability | ⊚ | ⊚ | ⊚ | ◯+ | X | ◯ |
| Processing stability over time | ⊚ | ◯ | ⊚ | ⊚ | | Δ |
| Flavor | ⊚ | ⊚ | ⊚ | ⊚ | | ⊚ |
| Heat-melting properties | ⊚ | ⊚ | ◯ | ⊚ | | ⊚ |

### <Results of Study 2>

From the results of Example 1 and Examples 6 and 7, it was recognized that even if the ratio of the starch treated with oxidation to the starch treated with hydroxypropylation was varied, it was possible to obtain the imitation cheese with good processing suitability, good processing stability over time, a good taste, and good heat-melting properties. Even when the hydroxypropyl starch was used as the starch treated with hydroxypropylation, it was possible to obtain the imitation cheese with good processing suitability, good processing stability over time, a good taste, and good heat-melting properties.

On the contrary, the imitation cheese in Comparative Example 4, which did not use the starch treated with oxidation, was too soft to be processed. The imitation cheese in Comparative Example 5, which did not use the starch treated with hydroxypropylation, was highly brittle in its physical properties, and severe collapse was observed, especially when the imitation cheese was processed after 60 days of storage, indicating poor processing stability over time.

Therefore, it was recognized that using a combination of the starch treated with oxidation and the starch treated with hydroxypropylation is needed to obtain the imitation cheese having the advantageous effects of the present invention.

### [Study 3]

The fat and oil to be used for the imitation cheese was studied.

In accordance with the formulations in Table 6, the imitation cheeses of Examples 9 to 11 and Comparative Example 6 were produced in the same manner as in the production method of the imitation cheeses in Study 1, except that the formulation of the fat and oil was varied.

TABLE 6

| | | (Reference) | | | | Comparative |
|---|---|---|---|---|---|---|
| | | Example 1 | Example 9 | Example 10 | Example 11 | Example 6 |
| (A) | Almond-derived protein material (1) | 2 | 2 | 2 | 2 | 2 |
| (B) | Oxidized starch | 16.3 | 16.3 | 16.3 | 16.3 | 16.3 |
| (C) | Hydroxypropyl distarch phosphate | 2.5 | 2.5 | 2.5 | 2.5 | 2.5 |
| (D) | Fat and oil D1 | 22.5 | | | | |
| | Fat and oil D2 | | 22.5 | | | |
| | Fat and oil D3 | | | 22.5 | | |
| | Fat and oil D4 | | | | 22.5 | |
| | Fat and oil D5 | | | | | 22.5 |
| Salt | | 2 | 2 | 2 | 2 | 2 |
| Potassium chloride | | 0.12 | 0.12 | 0.12 | 0.12 | 0.12 |
| Sodium glutamate | | 0.3 | 0.3 | 0.3 | 0.3 | 0.3 |
| Trehalose | | 3 | 3 | 3 | 3 | 3 |
| Agar | | 0.3 | 0.3 | 0.3 | 0.3 | 0.3 |
| Pectin | | 0.3 | 0.3 | 0.3 | 0.3 | 0.3 |
| 50%-fermented lactic acid | | 0.6 | 0.6 | 0.6 | 0.6 | 0.6 |
| Water | | 50.08 | 50.08 | 50.08 | 50.08 | 50.08 |
| Triglyceride | SSS content (% by mass) | 57.5 | 55.8 | 60.0 | 61.4 | 2.9 |
| composition | Tri-laurin content (% by mass) | 18.1 | 20.9 | 10.7 | 7.3 | 0.3 |
| in oil | Tri-laurin/SSS | 0.32 | 0.37 | 0.18 | 0.12 | 0.10 |
| phase*¹ | Oleoyl dipalmitin content | 0.6 | 0.4 | 0.9 | 1.0 | 63.1 |
| | (% by mass) | | | | | |
| | Tri-saturated fatty acid triglyceride | 2.1 | 0.2 | 5.5 | 7.3 | 2.4 |
| | consisting of solely saturated fatty | | | | | |
| | acid residues having the carbon | | | | | |
| | number of 16 to 22 content | | | | | |
| | (% by mass) | | | | | |

| | | | | | |
|---|---|---|---|---|---|
| Oil content (% by mass) | 22.8 | 22.8 | 22.8 | 22.8 | 22.8 |
| Water content (% by mass) | 53.7 | 53.7 | 53.7 | 53.7 | 53.7 |
| Protein content in imitation cheese (% by mass) | 1.0 | 1.0 | 1.0 | 1.0 | 1.0 |
| p H | 4.1 | 4.1 | 4.1 | 4.1 | 4.1 |

*¹S represents a saturated fatty acid residue having the carbon number of 12 to 22, and SSS represents tri-saturated triglyceride consisting of solely saturated fatty acid residues having the carbon number of 12 to 22.

### <Evaluation Method>

The resulting imitation cheeses were evaluated for the processing suitability, the processing stability over time, the taste, and the heat-melting properties, by using the same evaluation methods as in Study 1. The evaluation results are summarized in Table 7. The imitation cheese with the evaluation results of equal to or better than ∘ in all the evaluation items is considered to be an acceptable product.

TABLE 7

| | (Reference) | | | | Comparative |
|---|---|---|---|---|---|
| | Example 1 | Example 9 | Example 10 | Example 11 | Example 6 |
| Processing suitability | ⊚ | ⊚ | ⊚ | ◯+ | ◯ |
| Processing stability over time | ⊚ | ◯+ | ◯+ | ◯ | Δ |
| Flavor | ⊚ | ⊚ | ⊚ | ⊚ | ⊚ |
| Heat-melting properties | ⊚ | ⊚ | ◯+ | ◯+ | ◯+ |

### <Results of Study 3>

From the results of Example 1 and Examples 9 to 11, it was recognized that the imitation cheese satisfying (Condition 1) above had good processing suitability, good processing stability over time, a good taste, and good heat-melting properties. Furthermore, it was recognized that when the content of tri-laurin in the triglyceride composition in the oil phase, the value of tri-laurin/SSS, and the content of oleoyl dipalmitin were all within specific ranges, better processing suitability, better processing stability over time, and better heat-melting properties were obtained.

On the contrary, the imitation cheese in Comparative Example 6, which did not satisfy (Condition 1) above, rapidly became harder and more brittle in its physical properties after 60 days of storage, widespread collapse was observed when the imitation cheese was processed, and many shavings and powder were generated.

Therefore, it was recognized that in order to obtain the advantageous effects of the present invention, it is needed to satisfy (Condition 1), and that especially, the triglyceride composition in the oil phase contributes to the processing suitability and to the processing stability over time.

1. An imitation cheese comprising (A) a nut and seed, (B) a starch treated with oxidation, (C) a starch treated with hydroxypropylation, and (D) a fat and oil, the imitation cheese satisfying the following (Condition 1) and having a pH of 3.0 to 6.0:
(Condition 1): a content of a tri-saturated triglyceride formed of solely saturated fatty acid residues having the carbon number of 12 to 22 in a triglyceride composition in an oil phase is in the range of 30.0 to 70.0% by mass.

2. The imitation cheese according to claim 1, wherein an oil content in the ingredient (A) is 35.0% by mass or less.

3. The imitation cheese according to claim 1, wherein the ingredient (A) is an almond-derived protein material.

4. The imitation cheese according to claim 1, wherein a ratio of a content of the ingredient (C) to a starch content in the imitation cheese is in the range of 5.0 to 40.0% by mass.

5. The imitation cheese according to claim 3, wherein a ratio of a content of the ingredient (C) to a starch content in the imitation cheese is in the range of 5.0 to 40.0% by mass.

6. The imitation cheese according to claim 1, further satisfying (Condition 2) below:
(Condition 2): a content of tri-laurin in the triglyceride composition in the oil phase is in the range of 5.0 to 30.0% by mass.

7. A method for producing an imitation cheese, the imitation cheese including (A) a nut and seed, (B) a starch treated with oxidation, (C) a starch treated with hydroxypropylation, and (D) a fat and oil; the imitation cheese satisfying (Condition 1) below and having a pH of 3.0 to 6.0, the method comprising (Step 1) to (Step 5) below:
(Condition 1): a content of a tri-saturated triglyceride formed of solely saturated fatty acid residues having the carbon number of 12 to 22 in a triglyceride composition in an oil phase is in the range of 30.0 to 70.0% by mass;
(Step 1): a step of obtaining a mixture that contains the ingredients (A) to (D) described above and satisfies (Condition 1);
(Step 2): a step of adjusting a pH of the mixture to 3.0 to 6.0;
(Step 3): a step of homogenizing the mixture;
(Step 4): a step of heating the pH-adjusted mixture to 80° C. or higher; and
(Step 5); a step of cooling the mixture having been heated to 80° C. or higher to 20° C. or lower.

8. A food product containing the imitation cheese according to claim 1.
